(19) United States
(12) Patent Application Publication
(10) Pub. No.: US 2004/0200425 A1
(43) Pub. Date: Oct. 14, 2004

(54) Litter mat

(76) Inventor: Matthew J. Paquette, Medina, OH (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/752,412

(22) Filed: Jan. 6, 2004

Related U.S. Application Data
(60) Provisional application No. 60/438,089, filed on Jan. 6, 2003.

(51) Int. Cl. A01K 29/00

(52) U.S. Cl. 119/165

(57) ABSTRACT

A litter mat includes a base, a plurality of tufts, and a perimeter. The base includes a first substrate and a second substrate that is constructed from a non-slip material and is fixedly attached to the first substrate. The plurality of tufts are woven through the first substrate and extend in an angled upwardly direction therefrom. The perimeter of the base and includes an edge portion shaped to fit around a portion of a litter box.

### RELATED APPLICATION DATA

The present application is a non-provisional application based on, and claiming the priority benefit of, co-pending U.S. provisional application Serial No. 60/438,089, which was filed on Jan. 6, 2003, and is expressly incorporated by reference herein.

### FIELD OF THE DISCLOSURE

The present disclosure generally relates to cat litter products, and more particularly to a mat that is positionable near and/or beneath a litter box for capturing loose litter particles or granules that escape the litter box.

### BACKGROUND OF THE DISCLOSURE

It is well known that cat litter boxes are used to retain litter therein. It is also well known that when cats use the litter box, loose granules of litter escape the confines of the box and are easily displaced to areas well beyond the location of the litter box. Previous solutions have been devised to capture some of these loose granules of litter.

For example, fabric or non-woven mats or plastic molded trays are sometimes placed beneath a litter box or at least beneath the litter box entrance to assist in capturing loose litter granules. However, these types of products typically only capture a fraction of the loose litter granules, while the remainder of the loose granules escape even the confines of these mats or trays. Alternatively, many of these products are abrasive to the touch resulting in cats often avoiding these types of products altogether. Consumers typically are dissatisfied with the amount of cat litter that scatters when cats exit their litter box.

A number of litter collecting mats have also been devised. For example, U.S. Pat. No. 5,797,352 describes a mat having a plurality of parallel inclined louvers that are spaced at regular intervals. The louvers are described as being made of a flexible rubbery material. Each louver is elongate and extends the entire width of the mat.

As another example, U.S. Pat. No. 6,357,388 describes a litter mat having a plurality of upwardly extending projections. The projections are formed of thermoplastic polyolefin elastomer and engage a cat's paws when walking on the mat. The projections are said to dislodge litter caught within a cat's paws.

As a further example, U.S. Pat. No. 6,050,223 describes a mat that contains two types of upwardly extending projections. One type of the projections are shorter in length, larger in diameter, and flexible. The other type of projection is taller, smaller in diameter, and curved at the top. The curved part extends over and essentially hides the shorter projections. The two projections are said to work together to define a top surface that the cat walks on (curved part of taller projections) and a hidden surface that collects litter (area between shorter, thicker projections).

### SUMMARY OF THE DISCLOSURE

In accordance with one aspect of the disclosure, a litter mat for use with a litter box is disclosed. The litter mat includes a base having a first substrate, and a second substrate that constructed from a non-slip material and is fixedly attached to the first substrate. A plurality of tufts are woven through the first substrate that extend in an angled upwardly direction therefrom. A perimeter of the base includes an edge portion shaped to correspond to a portion of a litter box.

In accordance with another aspect of the disclosure, a litter box and litter mat kit is disclosed. The litter box and litter mat kit includes a litter box and a litter mat. The litter mat includes a base having a perimeter. The base extends beyond a litter box perimeter near an entry/exit point of the litter box. A plurality of tufts are woven through the base and extend in an angled upwardly direction therefrom.

In accordance with another aspect of the disclosure, a method of collecting cat litter is disclosed. The method includes providing a piece of indoor/outdoor carpeting. The method further includes shaping the piece of indoor/outdoor carpeting into a litter mat for use with a litter box, and placing the litter mat near the litter box.

### BRIEF DESCRIPTION OF THE DRAWINGS

FIG. 1 is a perspective view of a litter mat and litter box constructed in accordance with one example of the teachings of the present disclosure;

FIG. 2 is a sectional view of the litter mat of FIG. 1 along line 2-2;

FIG. 3 is a top plan view of the litter mat of FIG. 1;

FIG. 4 is the litter mat of FIG. 2 and showing collected litter granules; and

FIG. 5 is a table illustrating various test results of the litter mat in FIG. 1, and of other litter mats and materials having different compositions.

### DETAILED DESCRIPTION

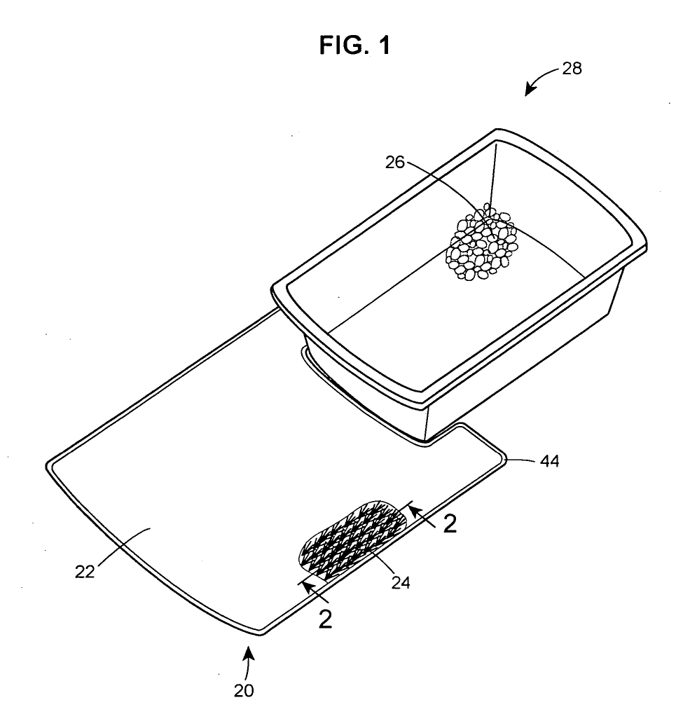

Referring now to the drawings and with specific reference to FIG. 1, a litter mat as constructed in accordance with the teachings of the disclosure is generally depicted by reference numeral 20. As shown therein, the litter mat 20 in this one exemplary embodiment includes a base 22 and a plurality of tufts 24.

The litter mat 20, as the name suggests, is adapted and used for the collection of litter 26 next to, underneath, or near a litter box 28. The litter 26 may be any kind of the commercially available litter, including but not limited to, clumping clay, non-clumping clay, pine litter, cedar litter, sand, wheat based litter, recycled newspaper, etc. Unlike the currently available litter mats, the litter mat 20 offers a combined level of litter collection and cleaning ease that the other litter mats may not offer. Additionally, the tufts 24, as disclosed herein, hide the litter 26 more effectively than past litter mats.

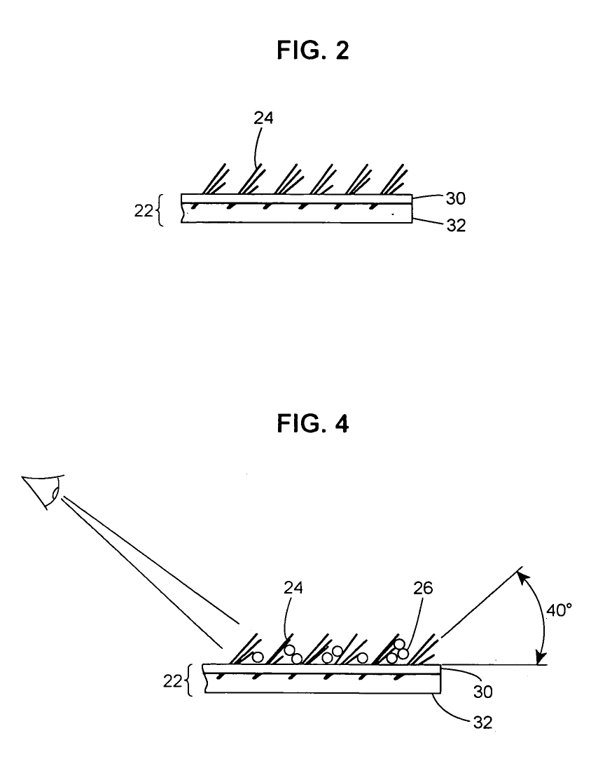

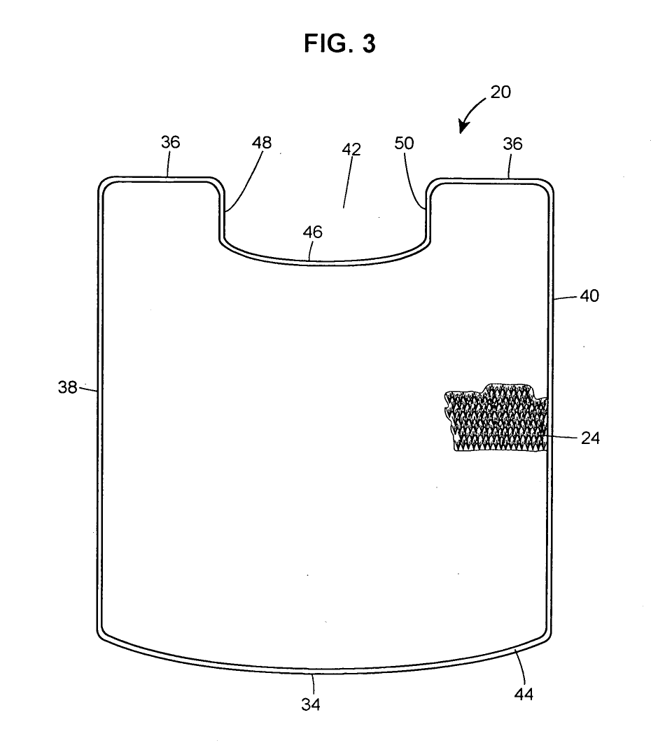

The base 22, as seen in FIG. 2, includes a first substrate 30 and a second substrate 32 in this example. As seen in FIG. 3, the base 22 further includes a front edge 34, a rear edge 36, a first side edge 38, and a second side 40, wherein the edges 34, 36, 38, and 40, generally define a perimeter of the litter mat 20.

As seen in FIG. 2, the first substrate 30 is disposed on top of the second substrate 32, and is adapted to engage and/or receive the tufts 24. More specifically, the first substrate 30 may be constructed from a woven, non-woven, and/or a hybrid woven/non-woven material through which the tufts 24 are placed. Similarly, the woven, non-woven, and/or a hybrid woven/non-woven material may be constructed from a material including, but not limited to, polypropylene, cotton, polyester, nylon and/or a combination thereof. The woven material may be used in constructing the first substrate 30 to give the base 22 certain properties, including but not limited to, strength and durability. The non-woven material may be used in constructing the first substrate 30 to give the base 22 additional or alternate properties, including but not limited to, resistance to fraying. The hybrid woven/non-woven material may chosen to achieve a combination of the properties exhibited by both the woven and on-woven material.

The tufts 24 may be woven through the first substrate 30, such that each of the tufts 24 are secured, or at least hooked through, the first substrate 30. The second substrate 32 may be disposed underneath the first substrate 30 as in this example, and/or on a bottom of the base 22 if more layers are present. Additionally, the second substrate 32 may be adapted to contain the tufts 24 in the first substrate 30 and/or aid in non-slippage of the litter mat 20. More specifically, the second substrate 32 may a latex rubber or synthetic rubber material having a basket weave emboss. As such, the combination of the first and second substrate 30, 32, as seen in FIG. 2, contain the tufts 24 in the base 22, while preventing the base 22 from slipping during use.

A border 44 may be disposed around at least a portion of the perimeter of the base 22, and, as in this exemplary embodiment, may be disposed around the entire perimeter of the base 22. The border 44 may be an extension of the first and/or the second substrate 30, 32, and may be formed such that the tufts 24 are prevented from falling out of the base 22. In other words, the border 44 may be formed around the perimeter of the base 22 such that the tufts 24 that are disposed toward the edges 34, 36, 38, and 40 of the base 22 are secured to the base 22. The border 44, as mentioned above, may be constructed as an extension of the first and/or the second substrate 30, 32, and/or may be constructed by adding material similar to the first and/or the second substrate 30, 32 to the perimeter of the base 22. As such, the litter box 28 may be disposed or placed at least partially on the border, either to prevent litter 26 from falling between an area of the litter mat 20 and the litter box 28, and/or to prevent the litter box 28 from moving relative to the litter mat 20 during use. Additionally and/or alternatively, the border 44 may be stitched, embroidered, or may be any other type of border 44 able to retain the tufts 24 disposed toward the edges 34, 36, 38, and 40, and/or able to receive the litter box 28.

The border 44 may, however, be wholly or at least partially missing or non-existent. For example, the litter mat 20 may be constructed, manufactured, trimmed or shaped without adding or having a border 44. As such, the base 22 and the tufts 24 may be constructed, manufactured and/or designed such that the tufts 24 are retained in the first and/or the second substrate 30, 32 near the perimeter of the base 22. For example, with the use of non-woven material or a combination of woven and non-woven material in the first substrate 30, the tufts 24 may be retained and/or prevented from fraying. More specifically, the non-woven material, in contrast to woven material, is created by one or more bonding methods, as opposed to a weaving method used for the woven material. The boding may be accomplished using several techniques such as, for example, using adhesive, chemical bonds, thermal bonds, etc. The non-woven material, therefore, may not fray or may not be prone to runs in the material, once cut or trimmed. Woven material in contrast, once cut or trimmed, may become frayed or be prone to runs in the material. As such, the non-woven material may better retain the tufts 24 in the base 22.

The tufts 24 extend from the base 22 and may be constructed from a non-absorbent material, and in this exemplary embodiment, may be constructed from a polypropylene ribbon material. The color or colors of the tufts 24 may also be chosen to aid in camouflaging and/or masking the litter 26 in the litter mat 20. In this exemplary embodiment, the tufts 24 have a black and gray color combination. Additionally and/or alternatively, the tufts 24 may be angled relative to the base 22. More specifically, as seen in FIG. 4, the tufts 24 may be angled relative to the base 22 at an angle between 300 and 50°, and more particularly, at an angle of approximately 40°, such that the tufts 24 cover the litter 26 and/or obscure the litter 26 from view. The tufts 24 may be angled in a particular direction to optimize camouflaging the litter 26, and in this exemplary embodiment, may be angled toward the rear edge 36 of the litter mat 20. Furthermore, when the litter mat 20 is oriented with the tufts 24 pointing toward the litter box 28, the angled tufts 24 can help to dampen the momentum of the scattering litter 26 coming from the litter box 28 and thus collect the litter 26 more efficiently.

A density of the tufts 24 may also contribute to litter collection and cleaning of the mat. More specifically, tufts 24 that are packed too tightly may not adequately collect or release the loose litter granules which may depend on the size and type of litter 26. Similarly, tufts 24 that are packed to sparsely, i.e., not densely enough, may not adequately collect or hide the litter 26, again which may depend on the size and type of litter. Density of the tufts 24 may be expressed in basis weight and/or in tufts/in, which may be further defined by tufts/in in the cross direction of the material and in tufts/in in the machine direction of the material. Tufts/in in the machine direction of the material may be defined as tufts/in in the direction the machine is tufting or tufts/in along a first axis that is parallel to the direction of manufacture, whereas the tufts/in in the cross direction of the material may be defined as the tufts/in in a direction ninety degrees relative to the machine direction or tufts/in along a second axis that is perpendicular to the first axis.

Therefore, the litter mat 20, in one example, may have a basis weight of 16 ounces per square yard, with 5.3 tufts/in in the cross direction of the material, and 8 tufts/in in the machine direction. Additionally, the pile, or the portion of the tufts 24 extending past the first substrate 30, may have a length or height of about 7 to about 8 mm.

The combination of the pile length and angle may provide optimum litter collection. The pile length shall be long enough to collect and hide small particles of litter 26. However, the pile should be short enough that it is easy to clean, i.e., it releases the litter 26 readily when shaken.

Returning to FIG. 3, the front and rear edges 34, 36 of the litter mat 20 may be generally parallel to each other in one example. The first and second side edges 38, 40 of the litter mat 20 may be generally parallel to each other and generally perpendicular to the front and rear edges 34, 36, as in this example. In this exemplary embodiment, the first and second side edges 38, 40 are longer than the front and rear edges 34, 36, thereby creating a litter mat 20 that has a generally rectangular shape. An edge portion of the litter mat 20 may be shaped to rest adjacent a litter box portion and/or correspond to at least a portion of the litter box 28. In this exemplary embodiment, the edge portion may be a notched area 42, and more specifically, may be a notched area 42 disposed near the rear edge 36 of the base for receiving a front potion of the litter box 28. The notched area 42 may further be disposed near a center of the rear edge 36 and may have a generally rectangular shape including an inner edge 46, a first side edge 48, and a second side edge 50. The notched area 42 may include the border 44 at one or more edges 46, 48, and 50 of the notched area 42, and as such, the litter box 28 may be disposed in the notched area 42, and/or may rest on one or more of the edges 46, 48, and 50 having the border 44. The edge portion may, however, be located elsewhere near the perimeter of the base 22, and more specifically, may be disposed near an entry and/or exit of the litter box 28. Additionally, the front edge 34 may have an arcuate shape, and more specifically, may have a convex arcuate shape.

The above exemplary embodiments may include many variations thereof to achieve and/or create additional or alternative features. For example, the overall shape of the litter mat 20 and the edge portion and/or the notched area 42 may be other than rectangular. For example, the litter mat 20 and/or the notched area 42 may be round, square, triangular, oval, odd shaped or a combination thereof. Similarly, the litter mat 20 may include an aperture (not show) to receive and/or correspond to the litter box 28. More specifically, the aperture may be located near a center of the litter box 20 and may have the same size and or shape of the litter box 28. As such, the litter box 28 may rest at least partially inside the aperture of the litter box 28 and/or rest wholly inside the aperture of the litter box 28.

The litter box 28 may also lack the aperture and or the edge portion altogether. The litter mat 20, for example, may be disposed under litter box 28, such that the pertinent part(s) of the litter mat 20 extend away from the litter box 28 where needed to collect the litter 26.

The materials of which the tufts 24, the first substrate 30, and the second substrate 32 are constructed, are also not limited to the materials disclosed, but may be constructed from many other materials, including, but not limited to, any type of plastic, ceramic, composite, rubber, latex, cotton, nylon, etc.

In operation, the litter mat 20 may be manufactured in an inexpensive and easy manner, thereby providing an affordable alternative to other litter mats known in the art. Additionally, the litter mat 20 has an improved ability to collect loose litter 26 and is easy to clean. To keep costs low, the material of which the litter mat 20 is constructed may be purchased as an off the shelf carpet sheet product, which can then be modified.

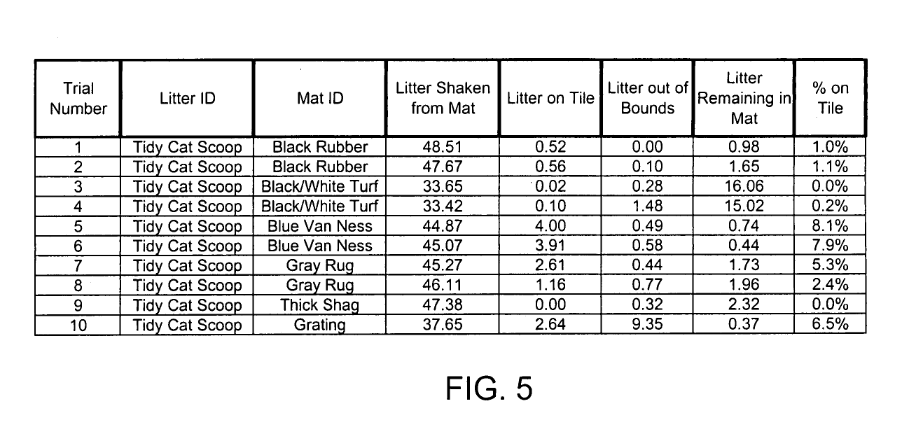

In choosing the best product or material for use as a litter mat 20, numerous potential materials were tested by throwing litter 26 onto mats constructed of the various materials in a repeatable manner and evaluating the mat characteristics. The mat characteristics include the ability to contain the litter in the material and the subsequent ease of cleaning the mat and/or removing the litter from the mat. Materials tested included current litter mat offerings on the market such as non-woven mats, molded trays, as well as other products, such as rubber boot mats, thick shag bathmats, and olefin outdoor carpeting. The olefin outdoor carpeting proved the best at both containing loose litter and sufficiently releasing the retained litter 26 when shaken out in the garbage. The test data can be seen in FIG. 5.

More specifically, the test results as seen in FIG. 5 were achieved by propelling a calculated amount of litter 26 from a litter box 28 onto and toward a center of the various materials and products of similar size in a repeatable manner. Data was then collected relating to the amount of litter 26 that was retained by the various materials and products during the testing. Column 6 of FIG. 5 identifies the amount of litter 26 (in grams) that went out of bound during testing. More specifically, the litter 26 that did not initially land on the various materials and products during testing is out of bound litter, and was not considered in determining and collecting the litter retaining data. For example, if litter 26 remained in the litter box 28 after being propelled toward the various materials and products that amount of litter 26 would not be included in the final litter retaining data. As such, the litter 26 in column 6 of FIG. 5, was litter 26 that never hit the litter mats and was not considered in the remainder of the litter retaining data. The remainder of the litter 26 that was not out of bounds is either in column 4, which indicates the amount of litter 26 that was shaken from the various materials and products, in column 5, which indicates the amount of litter 26 that bounced off the various materials and products, and in column 7, which indicates the amount of litter 26 that remained in the various materials and products after being shaken. Lastly, column 8 indicates in percentages, the amount of litter 26 that was bounced or ended up on the tile and/or was not retained by the various materials and products. As can be seen in column 8, the material providing the best result was the shag carpeting in row 9, which retained all of the litter 26. The shag carpeting, however, is difficult or nearly impossible to clean and easily absorbs moisture. More specifically, shag carpeting cannot be easily cleaned and dried using water soap and/or other solvents, as can the turf, and as such the shag carpeting was not chosen. The material having the second best result is the turf in rows 3 and 4, which retained all but 0.0% and 0.2% of the litter 26. The turf was also easy to clean and was, therefore, chosen.

The litter mat 20 of the type disclosed herein can be formed or cut to virtually any size or shape as desired. Thus, the litter mat 20 is flexible and can accommodate many different sized and shaped litter boxes 28 and litter 26 types and arrangements. Many of the prior art mats or trays are molded and are of one size and shape. A different mold tool must be fabricated to change size or shape characteristics. Thus, the litter mat 20 constructed as disclosed herein has many advantages over prior known loose litter collecting products.

The litter mat 20 constructed as disclosed herein can be cleaned merely by shaking the litter mat 20 over a trash receptacle, which may be more difficult to accomplish with shag carpeting, as the litter 26 may become lodged near between the pile. Furthermore, such the litter mat 20 can also be cleaned in the same manner as an indoor outdoor carpet, i.e., by vacuuming or spraying with water to dislodge loose litter retained within the pile without any substantial drying, if any. If, however attempted with shag carpeting this cleaning process would take additional time to clean and would have to be thoroughly dried.

While the above has been described with reference to specific examples which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. A litter mat for use with a litter box, comprising:
a base having a first substrate and a second substrate, wherein the second substrate is constructed from a non-slip material and is fixedly attached to the first substrate;
a plurality of tufts extending through the first substrate and in an angled upwardly direction therefrom; and
a perimeter having an edge portion shaped to correspond to a portion of a litter box.

2. The litter mat of claim 1, wherein the edge portion shaped to fit around a portion of a litter box is a notch.

3. The litter mat of claim 1, wherein the edge portion shaped to fit around a portion of a litter box is disposed near a center of the a rear edge of the litter mat.

4. The litter mat of claim 1, wherein the litter mat includes an arcuate edge.

5. The litter mat of claim 4, wherein the arcuate edge has a convex shape.

6. The litter mat of claim 1, wherein the tufts are constructed from a polypropylene material.

7. The litter mat of claim 1, wherein the first substrate is constructed from a hybrid woven and non-woven material.

8. The litter mat of claim 1, wherein at least one of the woven and non-woven material is constructed from a polypropylene material.

9. The litter mat of claim 1, wherein the second substrate is constructed from one of a latex rubber and synthetic rubber material.

10. The litter mat of claim 1, further including a third substrate attached to at least one of the first and second substrates.

11. The litter mat of claim 10, wherein the third substrate is constructed from one of a latex rubber and synthetic rubber material.

12. The litter mat of claim 1, wherein the tufts have a color combination adapted to mask litter collected on the mat.

13. The litter mat of claim 1, wherein the angle of the tufts relative to the base is between 30° and 50°.

14. The litter mat of claim 1, wherein the angle of the tufts relative to the base is approximately 40°.

15. The litter mat of claim 1, wherein the tufts are angled toward a part of the base intended to be adjacent to the litter box.

16. The litter mat of claim 1, wherein the litter mat retains at least ninety nine percent of litter propelled toward the litter mat.

17. The litter mat of claim 1, wherein the litter mat includes a border disposed around at least a portion of the perimeter.

18. A litter box and litter mat kit, comprising:
a litter box; and
a litter mat comprising:
a base having a perimeter, wherein the base extends beyond a litter box perimeter near an entry/exit point of the litter box; and
a plurality of tufts woven through the base and extending in an angled upwardly direction therefrom.

19. The litter box and litter mat kit of claim 18, wherein the base includes a first substrate and a second substrate.

20. The litter box and litter mat kit of claim 19, wherein the first substrate is constructed from a hybrid woven and non-woven material.

21. The litter box and litter mat kit of claim 20, wherein at least one of the woven and non-woven material is constructed from a polypropylene material.

22. The litter box and litter mat kit of claim 19, wherein the second substrate is constructed from a non-slip material.

23. The litter box and litter mat kit of claim 18, further including a notch disposed near the perimeter of the base for receiving the litter box.

24. The litter box and litter mat kit of claim 23, wherein the notch is disposed near the a center of a rear edge of the base.

25. The litter box and litter mat kit of claim 18, wherein the litter mat includes an arcuate edge as at least part of the perimeter.

26. The litter box and litter mat kit of claim 25, wherein the arcuate edge has a convex shape.

27. The litter box and litter mat kit of claim 18, wherein the tufts are constructed from a polypropylene material.

28. The litter box and litter mat kit of claim 19, wherein the second substrate is constructed from one of a latex rubber and synthetic rubber material.

29. The litter box and litter mat kit of claim 18, wherein the tufts have a color combination adapted to mask litter.

30. The litter box and litter mat kit of claim 18, wherein the angle of the tufts relative to the base is between 30° and 50°.

31. The litter box and litter mat kit of claim 18, wherein the angle of the tufts relative to the base is approximately 40°.

32. The litter box and litter mat kit of claim 18, wherein the litter box has one entry/exit and wherein the tufts are angled toward the entry/exit of the litter box.

33. The litter box and litter mat kit of claim 18, wherein the litter mat includes a border disposed around at least a portion of the perimeter.

34. A method of collecting cat litter, comprising:
providing a piece of indoor/outdoor carpeting;
shaping the piece of indoor/outdoor carpeting into a litter mat for use with a litter box; and
placing the litter mat near the litter box.

35. The method of collecting cat litter of claim 34, wherein shaping the piece of indoor/outdoor carpeting includes trimming the piece of indoor/outdoor carpeting to a generally rectangular shape.

36. The method of collecting cat litter of claim 34, wherein shaping the piece of indoor/outdoor carpeting includes creating a notch on an edge adjacent a litter box adapted to receive the litter box.

37. The method of collecting cat litter of claim 34, wherein placing the litter mat near a litter box includes facing angled tufts toward the litter box.

38. The method of collecting cat litter of claim 34, wherein placing the litter mat near a litter box includes pacing at least a portion of the litter mat under the litter box.

39. The method of collecting cat litter of claim 34, further including creating a border around at least a portion of a perimeter of the litter mat.

40. The method of collecting cat litter of claim 34, further including masking litter with a plurality of tufts of the litter mat.

41. The method of collecting cat litter of claim 34, wherein providing the piece of indoor/outdoor carpeting includes providing a first substrate constructed from a hybrid woven and non-woven material.

42. The method of collecting cat litter of claim 41, wherein providing the piece of indoor/outdoor carpeting further includes providing a second substrate constructed from one of a latex rubber and synthetic rubber material.

43. A litter mat for use with a litter box, comprising:
a base having a first substrate fixedly attached to a second substrate, wherein the first substrate is constructed from a hybrid woven and non-woven material, and the second substrate is constructed from a non-slip material; and
a plurality of tufts extending through the first substrate and in an angled upwardly direction therefrom.
